(19) United States
(12) Patent Application Publication
(10) Pub. No.: US 2025/0300596 A1
(43) Pub. Date: Sep. 25, 2025

(54) PHOTOVOLTAIC FASTENING SYSTEMS AND RELATED METHODS OF USE

(71) Applicant: The Board of Regents of the University of Oklahoma, Norman, OK (US)

(72) Inventor: Andres F. Cavieres Pinilla, Norman, OK (US)

(73) Assignee: The Board of Regents of the University of Oklahoma, Norman, OK (US)

(21) Appl. No.: 18/869,695

(22) PCT Filed: May 31, 2023
(86) PCT No.: PCT/US2023/023923

§ 371 Date: Nov. 26, 2024

Related U.S. Application Data
(60) Provisional application No. 63/347,314, filed on May 31, 2022.

(51) Int. Cl. H02S 30/10; F16B 5/06; H02S 40/32

(52) U.S. Cl. CPC H02S 30/10; F16B 5/0685; H02S 40/32

(57) ABSTRACT

A clamp for connecting a module-level power electronics (MLPE) device to a photovoltaic module frame may include an apex joint and two leg assemblies each extending downward from the apex joint. Each of the two leg assemblies may include an upper leg, a lower leg, a front receiver formed by a space between the upper and lower legs, and a rear receiver opposite the front receiver. Each leg assembly may further include locking tabs to abut against a vertical surface of the frame. An external force may be applied to the two leg assemblies to transition the legs between a compressed configuration and an engaged configuration.

### CROSS-REFERENCE TO RELATED APPLICATIONS

This application claims the benefit under 35 U.S.C. § 119 (e) of U.S. provisional application Ser. No. 63/347,314, filed May 31, 2022, the disclosure of which is incorporated by reference in its entirety.

### FIELD

The technology is generally related to photovoltaic clamping systems and methods. More specifically, systems and methods using spring-based clamps are disclosed.

### BACKGROUND

The most common approach to mechanically attach and electrically bond components used in the operation of solar panels (e.g., solar photovoltaic (PV) panels) to the panels or nearby mounting structures is through the use of conventional fasteners involving bolts, nuts, washers or rivets. PV mounting solutions that rely on conventional bolted connections are common in all major solar markets, including residential and commercial building rooftops, solar carports and canopies, as well as utility scale ground mount applications, both in fixed tilt and trackers.

### SUMMARY

In some embodiments, clamps for connecting a bracket to a frame are disclosed. The clamp includes two leg assemblies configured to move between a first compressed configuration with the two leg assemblies compressed towards one another and a second engaged configuration, a plurality of front receiver slots, each of the plurality of front receiver slots formed in a respective one of the two leg assemblies, wherein the plurality of front receiver slots are configured to receive a portion of the bracket and a portion of the frame therein, and a plurality of locking tabs formed at a leading end portion of a respective one of the two leg assemblies, the plurality of locking tabs configured to abut against a vertical surface of at least one of the bracket and the frame to prevent lateral movement of the clamp.

In other embodiments, clamping systems for clamping a solar panel assembly to a module-level power electronics (MLPE) device are disclosed. The system includes a bracket of the MLPE device, a frame of the solar panel assembly, and a clamp configured to approximate the bracket to the frame. The clamp includes two leg assemblies configured to move between a first compressed configuration with the two leg assemblies compressed towards one another and a second engaged configuration, a plurality of front receiver slots, each of the plurality of front receiver slots formed in a respective one of the two leg assemblies, wherein the plurality of front receiver slots are configured to receive a portion of the bracket and a portion of the frame therein and a plurality of locking tabs formed at a leading end portion of a respective one of the two leg assemblies, the plurality of locking tabs configured to abut against a vertical surface of at least one of the bracket and the frame to prevent lateral movement of the clamp.

In other embodiments still, methods of connecting a bracket to a frame are disclosed. The method includes applying an external force to two leg assemblies of a clamp to transition the two leg assemblies between a first compressed configuration a second engaged configuration, receiving a portion of the bracket and a portion of the frame within a plurality of front receiver slots, each of the plurality of front receiver slots formed in a respective one of the two leg assemblies, and preventing lateral movement of the clamp by abutting a plurality of locking tabs formed at a leading end portion of a respective one of the two leg assemblies against a vertical surface of at least one of the bracket and the frame.

In other embodiments still, clamps for connecting a bracket to a frame are disclosed. The clamp includes two leg assemblies configured to move between a first compressed configuration with the two leg assemblies compressed towards one another and a second engaged configuration, a plurality of front receiver slots, each of the plurality of front receiver slots formed in a respective one of the two leg assemblies, wherein the plurality of front receiver slots are configured to receive a portion of the bracket and a portion of the frame therein, and a plurality of shelves, each of the plurality of shelves formed in a trailing end portion of a respective one of the two leg assemblies, wherein the plurality of shelves are configured to receive at least a portion of the bracket therein.

In other embodiments still, clamping systems for clamping a solar panel assembly to a module-level power electronics (MLPE) device are disclosed. The system includes a bracket of the MLPE device, a frame of the solar panel assembly, and a clamp configured to approximate the bracket to the frame. The clamp includes two leg assemblies configured to move between a first compressed configuration with the two leg assemblies compressed towards one another and a second engaged configuration, a plurality of front receiver slots, each of the plurality of front receiver slots formed in a respective one of the two leg assemblies, wherein the plurality of front receiver slots are configured to receive a portion of the bracket and a portion of the frame therein, and a plurality of shelves, each of the plurality of shelves formed in at a trailing end portion of a respective one of the two leg assemblies, wherein the plurality of shelves are configured to receive at least a portion of the bracket therein.

In other embodiments still, methods of connecting a bracket to a frame are disclosed. The method includes applying an external force to two leg assemblies of a clamp to transition the two leg assemblies between a first compressed configuration a second engaged configuration, receiving a portion of the bracket and a portion of the frame within a plurality of front receiver slots, each of the plurality of front receiver slots formed in a respective one of the two leg assemblies, and receiving a portion of the bracket within a plurality of shelves, each of the plurality of shelves formed in at a trailing end portion of a respective one of the two leg assemblies.

In other embodiments still, clamps for connecting an MLPE device to a PV module frame are disclosed. The clamp includes an apex joint, two leg assemblies each extending downward from the apex joint, wherein each of the two leg assemblies includes an upper leg that includes upper teeth, a lower leg that includes lower teeth, an intermediate joint between the upper leg and the lower leg, a front receiver formed by a space between the upper teeth and the lower teeth, a rear receiver opposite the front receiver, and wherein the two leg assemblies are configured to move between an installation configuration in which two leg assemblies are compressed towards one another by an external force and a clamping configuration in which the two leg assemblies are pressed outward by a spring force applied by the apex joint and a spring force applied by the intermediate joint to the upper leg and lower leg of each of the two leg assemblies.

In other embodiments still, clamps for connecting an MLPE device to a PV module frame, wherein the PV module frame includes a mounting plate and the MLPE device includes a mounting bracket configured for connection to the mounting bracket, wherein the mounting bracket includes a slot, are disclosed. The clamp includes an apex joint, and two leg assemblies each extending downward from the apex joint, where the two leg assemblies are configured to move between an installation configuration in which two leg assemblies are compressed towards one another by an external force and a clamping configuration in which the two leg assemblies are pressed outward by a spring force applied by the apex joint, wherein each of the two leg assemblies includes an upper leg that includes upper teeth, a lower leg that includes lower teeth, a front receiver formed by a space between the upper teeth and the lower teeth, wherein the front receiver engages a front end of the slot and a portion of the mounting plate, and a rear receiver opposite the front receiver, wherein the rear receiver engages a rear end of the slot.

In other embodiments still, clamps for connecting a MLPE device to a PV module frame, wherein the PV module frame includes a mounting plate and a vertical member attached to the mounting plate, and wherein the MLPE device includes a mounting bracket configured for connection to the mounting bracket, are disclosed. The clamp includes an apex joint and two leg assemblies each extending downward from the apex joint, where the two leg assemblies are configured to move between an installation configuration in which two leg assemblies are compressed towards one another by an external force and a clamping configuration in which the two leg assemblies are pressed outward by a spring force applied by the apex joint, wherein each of the two leg assemblies includes an upper leg that includes upper teeth, a lower leg that includes lower teeth, wherein the lower leg is longer than the upper leg, a front receiver formed by a space between the upper teeth and the lower teeth, wherein the front receiver engages a front end of the slot and a portion of the mounting plate, and one or more locking tabs extending from a front end of the lower leg, wherein the locking tab of each leg assembly is configured to press against an outside surface of the vertical member when the mounting plate is captured within the front receiver.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 provides a perspective view of a portion of a conventional mounting frame for a PV module.

FIG. 2 provides a perspective view of a typical module-level power electronics (MLPE) device.

FIG. 3A-3D provide top, perspective, front, and side views of a clamp in accordance with some embodiments.

FIGS. 4A-4B illustrate a process of placement of the clamp onto a mounting bracket, in accordance with some embodiments.

FIGS. 5A-5B provide perspective and close-up views of a clamp partially engaged with a mounting bracket, in accordance with some embodiments.

FIGS. 6A-6B provide perspective and close-up views of a clamp in an assembled state with a mounting bracket, in accordance with some embodiments.

FIGS. 7A-7B provide cross-sectional depictions of an exemplary process of installing a clamp, in accordance with some embodiments.

FIGS. 8A-8D provide top, perspective, front and side views of a clamp in accordance with other embodiments.

FIGS. 9A-9B provide perspective and close-up views of a clamp in an assembled state with a mounting bracket, in accordance with some embodiments.

FIGS. 10A-10D provide perspective, front, top, and side views of a clamp in accordance with other embodiments still.

FIG. 11 provides a perspective view of a clamp in an assembled configuration with a mounting bracket, in accordance with some embodiments.

FIG. 12 provides a perspective view of a clamp in accordance with other embodiments still.

### DETAILED DESCRIPTION

Direct current (DC) power optimizers and microinverters (together known as module-level power electronics, or MLPE) are one of the fastest growing market segments in the solar industry. There are two main types of module-level Power Electronic (MLPE) devices. The first type is called an “optimizer” and is intended to monitor and optimize the performance of individual solar modules within a solar array. The second type is a micro-inverter, which transforms the direct current (DC) produced by a solar module into an alternating current (AC). This is different from the more conventional approach of using larger, centralized DC/AC inverters for an entire string of photovoltaic (PV) modules, or even entire arrays.

Most common MLPE devices include two main parts, (a) a housing which contains the electronic system itself, along with the wires for external electrical connections, and (b) a sheet-metal mounting bracket for the attachment of the device to a mounting plate of a supporting frame, such as a PV module frame. The mounting bracket of the MLPE device conventionally includes one or more offset slotted holes, which are used to affix the MLPE device to the frame with bolts, nuts, and washers. In most cases, at least one of the slot holes in the MLPE mounting bracket has an open end on the trailing edge of the bracket, to facilitate the insertion of a bolt stack by a sliding motion, rather than across the slot hole.

The Inventors have recognized that the use of conventional fasteners pose several problems. First, lack of standardization of panel sizes and MLPE dimensions requires vendors to customize mounting hardware for each solar project to match the specifications of different panels, which can extend manufacturing lead times and increase supply chain costs. Second, the use of bolted connections can increase the complexity and time required for panel installation, along with the risk of installer error. Conventional bolted connections typically require manual alignment and installation (e.g., threading of bolding, insertion of washers, placement of nuts, etc.) in conditions which are typically not ergonomic or comfortable for the installers. Finally, nuts and bolts must be tightened at specific torque values. The Inventors have recognized that achieving specific torque values in practice is very difficult to achieve. Over-torqueing is a common cause for the failure of bolts under high wind loads, whereas under-torqueing may lead to loose bolts and nuts, due to vibrations and other environmental conditions. This adds maintenance costs by requiring constant checking and re-tightening of large numbers of bolts and nuts on site.

As an alternative to the common use of bolts for securing the MLPE to the frame of a PV module, manufacturers have also developed custom brackets or clamps that are bolted to the MLPE device and then secured to the PV module frame. The bracket is attached to the mounting bracket of the MLPE device through its open slot hole, and then clamped against the mounting flange of the PV frame. However, such solutions are still prone to the above noted issues.

The Inventors have also recognized that existing mechanisms for securing the MLPE to the PV module also pose shortcomings. They require too many individual parts and assembly steps, and they are subject to loosening and failure due to under-torqueing and loosening caused by vibrations in the PV modules. Both of these shortcomings lead to increased costs, installation burden and unreliability.

In view of the above, the Inventors have recognized the benefits associated with a clamping system to facilitate the installation of components such as MLPEs, or other components, with photovoltaic systems or other systems that it is desirable to attach a component to. The clamping system may secure the MLPE to the existing PV frame without the use of bolts providing both a rapid and standardized installation. In some instances, the clamping system may both mechanically and electrically bond the MLPE to the PV frame in a manner that may withstand environmental conditions. However, instances in which different benefits are offered by the systems and methods disclosed herein are also possible.

In some embodiments, a spring-like clamp may be used to mechanically attach and electrically bond a Module Level Power Electronic (MLPE) device, or other component, to a photovoltaic (PV) module frame or other structure. In some embodiments, the clamp may be used to connect a mounting bracket of the MLPE device to a mounting plate (flange) of the PV module frame. The clamp may be used to attach devices or components other than MLPE device to the PV module frame, or to any other suitable mounting frame or substrate. The clamp may be made of a single piece of stamped, spring-based sheet metal, or other material with similar elastic behavior within a desired operating range of the clamp such that the clamp may be elastically deformed between a during assembly with one or more other components. In this way, manufacturing and procurement costs may be significantly reduced. By relying on a spring-based mechanism instead of torqueing a bolt stack, the solution is not only easier to install, but may also be inherently vibration resistant.

In some embodiments, the clamp may include two leg assemblies extending from an apex joint arranged centrally along the clamp. Each leg assembly may include an upper leg and a lower leg, connected to the upper leg through an intermediate portion extending therebetween, which may also be referred to as an intermediate joint herein. In some embodiments, a lower surface of the upper leg may include a plurality of teeth configured to scratch one or more components of the assembly for a more robust mechanical and electrical connection. Similarly, an upper surface of the lower leg may include a plurality of teeth configured to scratch one or more components of the assembly. In some embodiments, a front receiver slot may be formed between the teeth of the upper and lower legs. A stack including at least one body from an MLPE device and at least one body from a PV module frame, or other structures, may be arranged and received within the receiver slot when the system is in an assembled configuration.

In some embodiments, the clamp may also include a back receiver slot formed in a trailing end portion of the upper and/or lower leg opposite from the associated receiver slots formed in the leg assemblies. The back receiver slot may be configured to enhance the clamping capability of the clamp by permitting a portion of the structures (e.g., a portion of an MLPE device and PV module frame) to be received and supported therein when in an assembled state. In some embodiments, the vertical height of the back receiver slot may be less than a vertical height of the front receiver slot, as the back receiver slot may be configured to receive one less body than the front receiver slots (e.g., only one of a portion of the MLPE device and/or PV module frame). Of course, embodiments having front and back receiver slots of approximately the same vertical heights are also contemplated.

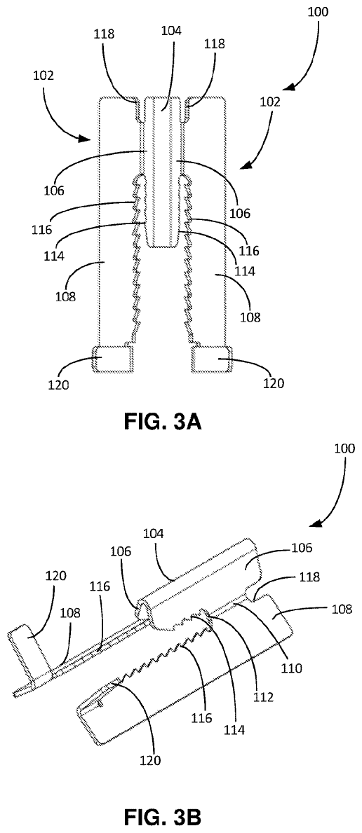

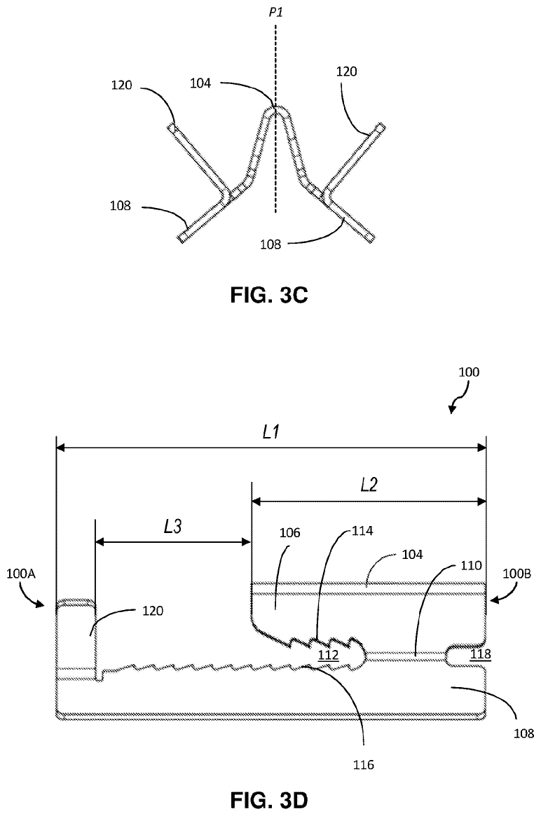

In some embodiments, the clamp may include back receiver shelves formed only in the trailing end portion (e.g., at trailing end portion 100B, as shown in FIG. 3D) of the lower legs. The back receiver shelf may serve to apply a downward force to the bodies captured and/or abutting against the back receiver shelf, irrespective of the thickness of the bodies, as will be described in greater detail below.

At its leading end portion, the clamp may include one or more locking tabs to prevent lateral movement of the clamp following assembly. The locking tabs may be spaced apart from the upper leg at a distance which may correspond to a width of a component, such as a PV module frame. Accordingly, the locking tabs may serve to lock in the frame laterally and reduce the likelihood of movement. As will be described in greater detail below, the locking tabs may be spring-loaded, or may be manually operated to facilitate their locking function. In some embodiments, each leg assembly may include more than one locking tab to accommodate a variety of component width sizes.

As will be described in greater detail below, the clamp may be transitioned between an initial unbiased configuration and a clamped and engaged configuration through the application of an external force applied to the lower legs which causes the leg assemblies to bend towards one another. In some embodiments, the leading end portion of the lower legs may include a handling portion, which may not extend along a portion, or the entire, length of the lower legs. The handling portions may serve to facilitate expanding the front receivers by applying a torsional or twisting force on the lower legs, relative to the upper legs. In some embodiments, the handling portions may also provide an ergonomic handle for the operator to rapidly and comfortably operate the clamps.

Before describing various embodiments of the present disclosure in further detail by way of exemplary description, examples, and results, it is to be understood that the apparatus and methods of the present disclosure are not limited in application to the details of specific embodiments and examples as set forth in the following description. The description provided herein is intended for purposes of illustration only and is not intended to be construed in a limiting sense. As such, the language used herein is intended to be given the broadest possible scope and meaning, and the embodiments and examples are meant to be exemplary, not exhaustive. Also, it is to be understood that the phraseology and terminology employed herein is for the purpose of description only and should not be regarded as limiting unless otherwise indicated as so. Moreover, in the following detailed description, numerous specific details are set forth in order to provide a more thorough understanding of the present disclosure. However, it will be apparent to a person having ordinary skill in the art that the present disclosure may be practiced without these specific details. In other instances, features which are well known to persons of ordinary skill in the art have not been described in detail to avoid unnecessary complication of the description. It is intended that all alternatives, substitutions, modifications, and equivalents apparent to those having ordinary skill in the art are included within the scope of the present disclosure. Thus, while the apparatus and methods of the present disclosure have been described in terms of particular embodiments, it will be apparent to those of skill in the art that variations may be applied to the apparatus and methods and the steps or in the sequence of steps of the methods described herein without departing from the concept, spirit, and scope of the inventive concepts.

Unless otherwise defined herein, scientific and technical terms used in connection with the present disclosure shall have the meanings that are commonly understood by those having ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the present disclosure pertains. All patents, published patent applications, and non-patent publications referenced in any portion of this application, including U.S. Provisional Patent Application Ser. No. 62/742,713, filed Oct. 8, 2018, PCT patent application PCT/US2019/055260, filed Oct. 8, 2019 (published as WO 2020/076870), and U.S. Ser. No. 16/757,386, filed Apr. 18, 2020 (published as US 2021/0313926 A1), are herein expressly incorporated by reference in their entirety to the same extent as if each individual patent or publication was specifically and individually indicated to be incorporated by reference.

As utilized in accordance with the methods and apparatus of the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the term “at least one” will be understood to include one as well as any quantity more than one, including but not limited to, 2, 3, 4, 5, 6, 7, 8, 9, 10, 15, 20, 30, 40, 50, 100, or any integer inclusive therein. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z.

As used herein, all numerical values or ranges (e.g., in units of length such as micrometers or millimeters) include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-50 therefore includes 1, 2, 3, 4, 5, 6, 7, 8, 9, 10, 11, 12, 13, 14, 15, 16, 17, 18, 19, 20, etc., up to and including 50, as well as 1.1, 1.2, 1.3, 1.4, 1.5, etc., 2.1, 2.2, 2.3, 2.4, 2.5, etc., and so forth. Reference to a series of ranges includes ranges which combine the values of the boundaries of different ranges within the series. Thus, to illustrate reference to a series of ranges, for example, of 1-10, 10-20, 20-30, 30-40, 40-50, 50-60, 60-75, 75-100, 100-150, 150-200, 200-250, 250-300, 300-400, 400-500, 500-750, 750-1,000, includes ranges of 1-20, 10-50, 50-100, 100-500, and 500-1,000, for example. For example, a reference to a range of 1 mm to 20 mm in thickness is intended to explicitly include all units of measurement in the range.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Throughout this application, the terms “about” or “approximately” are used to indicate that a value includes the inherent variation of error. Further, in this detailed description, each numerical value (e.g., thickness, length, temperature or time) should be read once as modified by the term “about” (unless already expressly so modified), and then read again as not so modified unless otherwise indicated in context. As noted above, any range listed or described herein is intended to include, implicitly or explicitly, any number within the range, particularly all integers, including the end points, and is to be considered as having been so stated. For example, “a range from 1 to 10” is to be read as indicating each possible number, particularly integers, along the continuum between about 1 and about 10. Thus, even if specific data points within the range, or even no data points within the range, are explicitly identified or specifically referred to, it is to be understood that any data points within the range are to be considered to have been specified, and that the inventors possessed knowledge of the entire range and the points within the range. Unless otherwise stated, the term “about” or “approximately”, where used herein when referring to a measurable value such as an amount, length, thickness, a temporal duration, and the like, is meant to encompass, for example, variations of ±20% or ±10%, or ±5%, or ±1%, or ±0.1% from the specified value, as such variations are appropriate to perform the disclosed methods and as understood by persons having ordinary skill in the art.

As used herein, the term “substantially” means that the subsequently described parameter, event, or circumstance completely occurs or that the subsequently described parameter, event, or circumstance occurs to a great extent or degree. For example, the term “substantially” means that the subsequently described parameter, event, or circumstance occurs at least 80% of the time, or at least 90%, or at least 91%, or at least 92%, or at least 93%, or at least 94%, or at least 95%, or at least 96%, or at least 97%, or at least 98%, or at least 99%, of the time, or means that the dimension or measurement is within at least 90%, or at least 91%, or at least 92%, or at least 93%, or at least 94%, or at least 95%, or at least 96%, or at least 97%, or at least 98%, or at least 99%, of the referenced dimension or measurement (e.g., length or thickness).

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Although the term of reference “horizontal” may be used in this disclosure, the clamping systems and methods of the present disclosure may also be used in non-horizontal applications, such as in vertical or semi-vertical orientations. Similarly, although the term of reference “vertical” may be used in this disclosure, the clamping systems and methods of the present disclosure may also be used in non-vertical applications, such as in horizontal or semi-vertical orientations.

In some embodiments, the clamp may be used in rooftop applications, such as solar panels installed on residential or commercial building rooftops. The clamp may also be used to install MLPE devices on solar panels installed on other parts of buildings, including walls, parapets, awnings, etc. Moreover, the clamp may be used for attachment of MLPE devices on ground-mount solar systems, for example at utility scale, such as in solar carports, fixed-tilted systems, and single axis trackers (SAT), or in floating systems, where solar panels are installed over bodies of water. By reducing hardware and labor costs associated with mechanical attachment and electrical bonding of MLPE devices, the disclosed clamps can have a very significant impact.

It should be appreciated that although the clamps of the present disclosure are generally described to facilitate the assembly of MLPE devices with solar panels, the clamps may be used to facilitate the connection between any structural components. It will also be understood that the clamps described herein may be used to connect and assemble structural members used in applications other than solar panels. For example, the clamp may be useful in connecting structural members within the chassis of appliances or to assist with the assembly of metal buildings.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

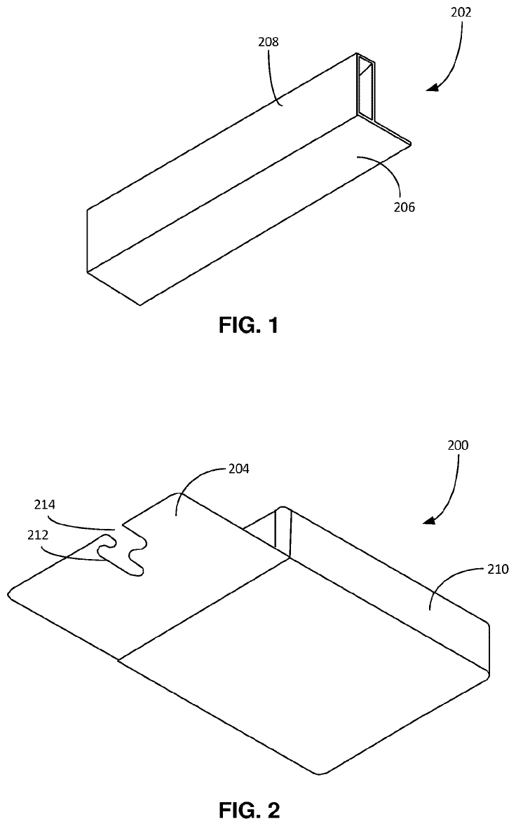

FIG. 1 shows an exemplary conventional PV module frame 202. A mounting plate 206 of the PV module frame 202 may extend at a substantially perpendicular orientation from a vertical member 208. In some embodiments, a clamp may be used to fasten the PV module frame to an MLPE device 200, as depicted in FIG. 2. The MLPE device may include a component housing 210 secured to a mounting bracket 204. The mounting bracket 204 may include one or more slots 212 that are designed for use with conventional bolt fasteners. The slot 212 can include an opening 214 that is offset from the slot 212, to facilitate sliding the mounting bracket 204 over a bolt or other fastener extending through the PV module frame 202. It will be appreciated that the MLPE device 200 and the PV module frame 202 illustrated in FIGS. 1 and 2 are exemplary, and that the clamps described herein may fasten any suitable conventional PV module frame to any suitable conventional MLPE device. It will be appreciated that the clamps of the present disclosure may be used to connect components in other industries, where the components include features resembling the mounting bracket 204, slot 212 and mounting plate 206.

FIGS. 3A-3D show top, perspective, front and side views of a clamp 100 for fastening an MLPE device to a PV module frame, according to some embodiments. The clamp 100 may include at least two legs or leg assemblies 102 connected at an apex joint 104 disposed between the at least two legs. The apex joint 104 may be curved and integrated as a unitary component with each of the legs or leg assemblies 102. The apex joint 104 may be configured such that the angle between the leg assemblies 102 is an acute angle. In some embodiments, as depicted in FIG. 3C, the leg assemblies 102 extend away from the apex joint 104 at an angle of between about 10 and 90 degrees. Although the embodiment of the clamp 100 depicted in FIGS. 3A-3D is generally “V-shaped,” it will be appreciated that the clamp 100 can also be constructed in other configurations including, but not limited to, “W-shaped” and “Y-shaped” embodiments.

It should be appreciated that the apex joint 104 may be configured to be inserted into a slot of an MLPE device. In some embodiments, the angle of the leg assemblies and a width of the apex joint distance between the opposing upper legs, which may also be referred to as an upper leg portion herein, may be sized and shaped to be small enough or otherwise suited to readily pass through a width of the slot. Accordingly, the apex joint may have any suitable geometry to enable its insertion into an appropriate slot.

In some embodiments, each leg assembly 102 may include an upper leg 106 and a lower leg 108, which may also be referred to as a lower leg portion, which are connected together at an intermediate joint 110, which may also be referred to as an intermediate portion of the leg. The intermediate joint 110 may be integrated as a unitary component between the upper leg 106 and the lower leg 108. In exemplary embodiments, the intermediate joint 110 may be configured such that the lower leg 108 is flared outward at an obtuse angle relative to the upper legs and apex joint. In some embodiments, as depicted in FIG. 3C, the intermediate joint 110 creates an oblique angle of between about 90 and 180 degrees between the upper leg 106 and the lower leg 108.

In some embodiments, the lower leg 108 may be sized and shaped to abut against the slot of the MLPE device when the apex joint is inserted into the slot. In other words, the lower leg 108 may be angled from the upper leg 106 in a way that generally prevents the passage of the entire body of the clamp 100 across the height of the slot. This may correspond to a distance between the opposing lower legs being greater than a distance between the opposing upper legs and apex joint. The interface between the lower leg and the MLPE device, or other slot the clamp is inserted into, may prevent the clamp from passing completely through the slot and may allow for improved fastening by the clamp. Of course, embodiments wherein the entirety of the clamp may pass through the slot are also contemplated.

As best illustrated in FIG. 3D, the lower leg 108 may be substantially longer than the upper leg 106 in the length-wise direction of the clamp 100 such that the upper leg and lower leg may extend in a first direction that is parallel to a longitudinal direction of the device and the lower leg may extend beyond the upper leg in the longitudinal direction. In some embodiments, a length L1 of the lower leg 108 may be about twice the length L2 of the upper leg 106. It should be appreciated that other proportions between the length of the lower leg and the upper leg are also contemplated. In some embodiments, the lower leg length L2 may be compatible with a length of a slot formed in an MLPE, or other component to be attached to a structure, such that the clamp may be inserted in the slot in a vertical fashion.

In some embodiments, a front receiver 112, which may be referred to as a front receiver slot, may be formed by the space between the upper leg 106 and the lower leg 108. The upper leg 106 may include upper teeth 114 that extend into an upper side of the front receiver 112. The lower leg 108 may include lower teeth 116 that extend into a lower side of the front receiver 112. The lower teeth 116 extend substantially along the length of the lower leg 108. In this way, the lower leg 108 and the lower teeth 116 extend well beyond the leading end (e.g., see leading end portion 100A of the clamp in FIG. 3D) of the upper leg 106. It should be appreciated that the teeth of both the upper and lower leg may be shaped and sized to scratch the surface of the MLPE and/or PV frame to enable electrical contact, and in some instances, improved mechanical contact through friction.

In some embodiments, the front receivers may be sized and shaped to accommodate at least a portion of the MLPE and PV frame. For example, a height or clearance of the front receivers may be sized commensurate with a stacked height of the MLPE and PV frame. As will be described in greater detail below, the height or clearance of the front receivers may be adjusted through compression of the leg assemblies toward one another.

Each leg assembly may further include a back receiver 118, which may be referred to as a back receiver slot. In the embodiments depicted in FIGS. 3A-3D, the back receiver 118 is arranged on the leg assembly, separated from the front receiver 112 by the intermediate joint 110. In some embodiments (not shown), the back receiver 118 includes teeth or other grip-inducing features. The back receivers may be arranged along the same longitudinal axis as the front receivers 112. In some embodiments, the back receivers 118 may be aligned with the front receivers 112. In some embodiments, the back receivers 118 may be co-linear with the front receivers 112. As shown in FIG. 3B, the back receivers 118 may be formed on a portion of the leg assembly opposite from the front receivers 112. In some embodiments, the front and back receivers may be formed at least partially in both the upper 106 and lower 108 legs of the leg assemblies. For example, the back receivers 118 may be arranged in between the upper and lower legs of the leg assemblies. In other embodiments, one or more of the receivers may be formed in only one portion of the leg assemblies.

The back receivers 118 may be arranged at a backside, or trailing end portion 100B of the clamp 100, as shown in FIG. 3D, whereas the front receivers 112 may be arranged between the trailing end portion 100B and the leading end portion 100A of the clamp 100. The back receivers may serve to secure the clamp on the MLPE device during installation. In some embodiments, the back receivers may also serve to secure the clamp to the MLPE device after installation. Accordingly, the back receivers may have a height or clearance to accommodate a thickness of the MLPE device.

In some embodiments, a leading end portion (arranged at the leading end 100A of the clamp, as shown in FIG. 3D) of each of the lower legs 108 may include one or more locking tabs 120 that each extends outward from the lower leg 108 at an angle, as shown in FIGS. 3B-3C. The locking tabs 120 may be arranged at an opposite end of the clamp relative to the back receivers 118, which may be arranged at a trailing end portion (arranged at the trailing end 100B of the clamp, as shown in FIG. 3D) of the leg assemblies. In some embodiments, the locking tab 120 may extend away from the lower leg at an angle between about 70 and 110 degrees, although other configurations are also contemplated. The locking tabs 120 may be connected to the leading portion of the lower leg 108, as shown in FIG. 3D. The locking tabs may extend from an upper surface of the lower leg, past the height of the upper surface of the front receiver 112, as shown in FIG. 3D.

As shown in the front view of FIG. 3C, the locking tabs 120 may be oriented along a plane angled relative to the lower leg portions 108. In some embodiments, the locking tabs 120 may be angled relative to the upper leg portions 106. In other embodiments, the locking tabs may lie on a plane parallel to the plane of the upper leg portions. The locking tabs 120 are configured to be flexible, elastic, and resilient such that the locking tabs 120 may be temporarily deflected downward through the application of force to the top of the locking tabs 120. When the force applied to the top of the locking tabs 120 is released, the locking tabs 120 return to their pre-biased, relaxed position. It should be appreciated that the locking tabs may be angled relative to a vertical plane P1, shown in FIG. 3C, such that they may be readily deflected during installation. The locking tabs may be flexible, such that they may deflect or rotate around the hinged connected with the lower leg. During installation, the locking tabs may rotate around their hinged connection, and flatten relative to the vertical plane of the clamp (see plane P1 of FIG. 3C). Therefore, during installation, the effective vertical extension of the locking tabs may be lower than the upper surface of the front receiver 112. Once the clamp reaches its final locked position, the locking tabs may rotate back around their hinged connection, such that the effective vertical extension of the locking tabs may be higher than the upper surface of the front receiver 112.

In some embodiments, the flexible locking tabs 120 may be spaced away from the upper leg 106 by a length L3, as shown in FIG. 3D. The length L3 may provide clearance for the insertion of the clamp 100 when in a compressed state, and to lock the clamp 100 against a bearing surface of the vertical member 208 when the compression is released. In other words, the length L3 between the upper leg 106 and the locking tabs 120 may be commensurate with, or slightly greater than, a length of the mounting plate (see plate 206 in FIG. 1). The locking tabs 120 may therefore enable length-wise compression of the mount plate by the clamp 100. In some embodiments, the flexible locking tabs may prevent lateral movement of the clamp relative to the bracket and frame, locking the assembly together.

In some embodiments, the leg assemblies 102 may be compressed together to reduce the angle created by the apex joint 104. Applying a compressive force between each of the lower legs 108 may also expand the angle created by each of the intermediate joints 110 between the upper 106 and lower 108 legs. As the leg assemblies 102 are compressed together, the V-shaped geometry of the leg assemblies 102 may cause the front receivers 112 and back receivers 118 to become more vertically oriented, which increases the effective vertical height of the pass-through gaps that extend between each of the front receivers 112 and back receivers 118. In other words, compression of the leg assemblies may serve to increase a clearance height formed in each of the front receivers 112 and the back receivers 118. Accordingly, during installation, the leg assemblies may be compressed (manually or with the use of a tool) to help expand the vertical clearances in the front and back receivers, to accommodate the various structural elements configured to be received within the clamp. In this way, compressing the leg assemblies 102 together expands the effective height of the front receivers 112 and back receivers 118 to accommodate the insertion of one or more plates or flanges.

Due to the angular disposition of the leg assemblies 102 and the orientation of the front 112 receivers within the leg assemblies, the front receivers together may provide a first clearance that represents the height of the linear gap that extends through the two front receivers 112. When the legs assemblies of the clamp 100 are approximated under an external compressive force, the angular disposition of the leg assemblies 102 and the front receivers may be reduced to a second clearance, which may be greater than the first clearance. In some embodiments, the second clearance may be approximately greater than or equal to the combined thickness of the PV module frame and the MLPE device mounting bracket, while the first clearance may be less than the combined thickness (height) of the components. In these embodiments, the clamp 100 may not be able to accommodate the two components until the combined clearance from the front receivers 112 is increased by compressing the leg assemblies together.

When the compressive force is removed from the clamp 100, the leg assemblies may be urged to separate by the spring force of the clamp 100, resulting in a reduction of the clearance provided by the front receivers 112. When the compressive force is released, the leg assemblies 102 may return to their original configuration of extending away from one another under the spring force of the apex joint 104, intermediate join 110 and the lower leg 108, thereby reducing the height of the clearance (which may be a vertical gap) that extends between each of the front receivers 112 and back receivers 118. It should be appreciated that the intermediate joint may allow the lower leg to deflect relative to the upper leg, such that the lower leg may serve as a leaf spring.

Releasing the compressive force allows the leg assemblies 102 to deflect outward to reduce the effective height of the front receivers and back receivers 118 to apply a clamping force to the one or more components captured within the front receivers 112 or back receivers 118. Moreover, such a clamping process may serve to engage at least one of the upper teeth 114 and/or the lower teeth 116 against the various components positioned within the various receivers. Since the combined thickness of the PV module frame and the MLPE device mounting bracket may be greater than the clearance provided by the front receivers 112 when the clamp 100 is in a relaxed state, the introduction of the PV module frame and the MLPE device mounting bracket within the front receivers 112 may inhibit the clamp 100 from fully returning to its relaxed state. In this way, the spring force of the clamp 100 may exerts an outward force on the leg assemblies, which may be transferred through the front receivers 112 as a compressive force that holds the PV module frame and the MLPE device mounting bracket. In some embodiments, the teeth may scratch the surface of the mounting plate and/or MLPE device to provide an electrical bonding path between the mounting plate of the PV module frame, and the mounting bracket of the MLPE device.

In some embodiments, the apex joint arranged between the two leg assemblies of the clamp may allow the clamp to act in a spring-like manner. Similarly, in some embodiments, each leg assembly may include an intermediate joint arranged between the lower and upper legs to allow each leg assembly to act in a spring-like manner. As shown in FIG. 3C, it should be appreciated that the obtuse angles formed by the intermediate joints 110 may reduce the effective clearance between the upper teeth 114 and the lower teeth 116 of the front receivers 112, which may improve the ability of the clamp 100 to accommodate plates of varying thicknesses to be captured within the front receiver 112. Accordingly, the intermediate joint 110 may allow the clamp 100 to be used for securing mounting brackets 204 and mounting plates 206 having a broad range of stacked thicknesses.

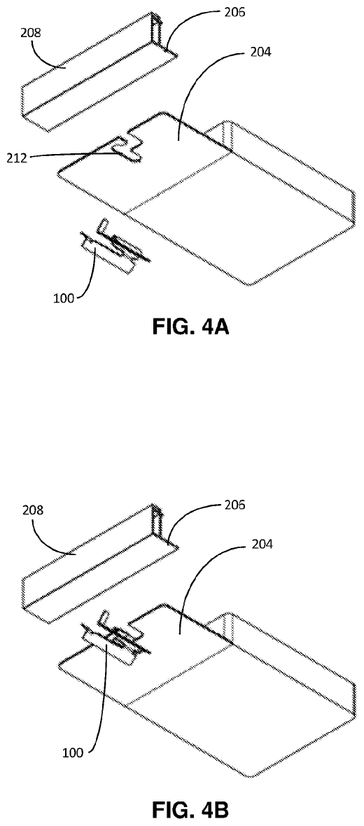

Turning to FIGS. 4A-4B, shown therein is an exemplary process for attaching a clamp 100 to an MLPE device 200. The clamp 100 may be inserted through a slot 212 in the mounting bracket 204. In an exemplary, non-limiting embodiment, the apex joint 104 may be vertically inserted into the slot 212 from the bottom of the mounting bracket 204, as shown in the process of FIGS. 4A-4B. Depending on the relative geometries between the slot 212 and the clamp 100, the legs or leg assemblies 102 may need to be compressed together to permit the upper legs 106 to pass through the slot 212. When the clamp 100 extends through the slot 212, the rear side of the slot 212 can then be captured within the back receiver 118 of the clamp 100. In this way, the clamp 100 may be pre-installed and secured within the slot 212 of the MLPE mounting bracket 204. After attachment of the MLPE mounting bracket 204 to the mounting plate 206 of the PV module frame 202 or other support structure, the MLPE device 200 may cantilever away from the mounting plate 206. The engagement between the rear portion of the slot 212 and the back receiver 118 allows the mounting bracket 204 to carry the weight of the MLPE device 200 in its cantilevered orientation.

It should be appreciated that although generally horizontal attachments (relative to gravity) have been described, the clamps of the present disclosure may be employed to clamp or secure non-horizontal components. For example, the clamp may be used to secure two vertical components together. In some embodiments, the clamp may be used to secure two components which may be angled relative to gravity. Accordingly, the present disclosure is not limited by the orientation of the components secured with the clamps described herein.

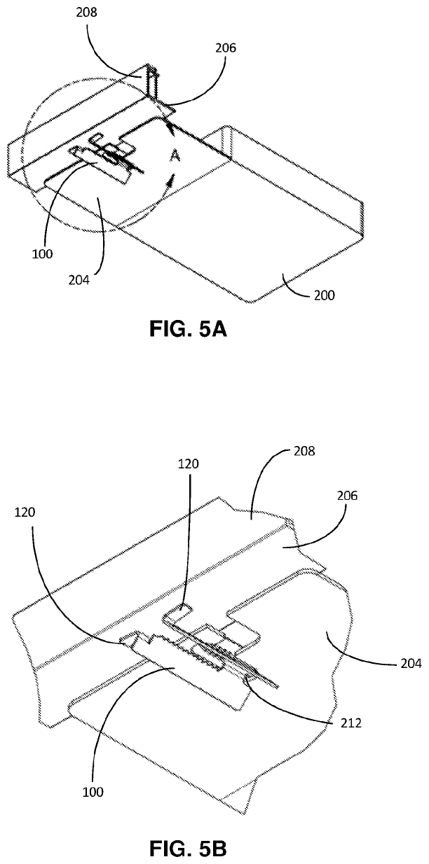

FIG. 5A shows an in-process assembly of a clamp 100, mounting bracket 204, and mounting plate 206 according to some embodiments. FIG. 5B shows a close-up view of FIG. 5A along detail A. As shown, the mounting plate 206 and the mounting bracket 204 may be both positioned within the receivers of the clamp 100. At the configuration represented by FIGS. 5A-5B, the clamp 100 may be in the process of, but not yet completed, its fastening of the mounting bracket and mounting plate. As shown, the locking tabs 120 of the clamp 100 may be deformed, or flattened, against the bottom surface of the mounting plate during this stage of the assembly to permit the clamp to slide relative to the other structures. Specifically, when the mounting bracket 204 is pressed against the mounting plate 206, the flexible locking tabs 120 of the clamp 100 deflect downward against a spring force. Thus, the flexibility of the locking tabs 120 may allow the clamp to be bent to allow the clamp to traverse across the mounting plate.

It should be appreciated that the direction of deflection of the flexible locking tabs may be dependent upon the installation direction of the clamp relative to gravity. Thus, although downwardly deflecting tabs are shown in FIGS. 5A, tabs deflecting in other directions are also contemplated. The locking tabs may deflect in any suitable direct to allow the clamp to slide along the mounting plate and secure the various components within the front receivers of the clamp.

It should also be appreciated that although the mounting plate 206 is shown to be arranged above the mounting bracket 204 within the stack positioned in the clamp 100, embodiments in which the mounting plate 206 is positioned underneath the mounting bracket 204 are also contemplated. It should be appreciated that any suitable arrangement of components may be positioned in the receivers of the clamp to facilitate the fastening of the components, as the present disclosure is not so limited.

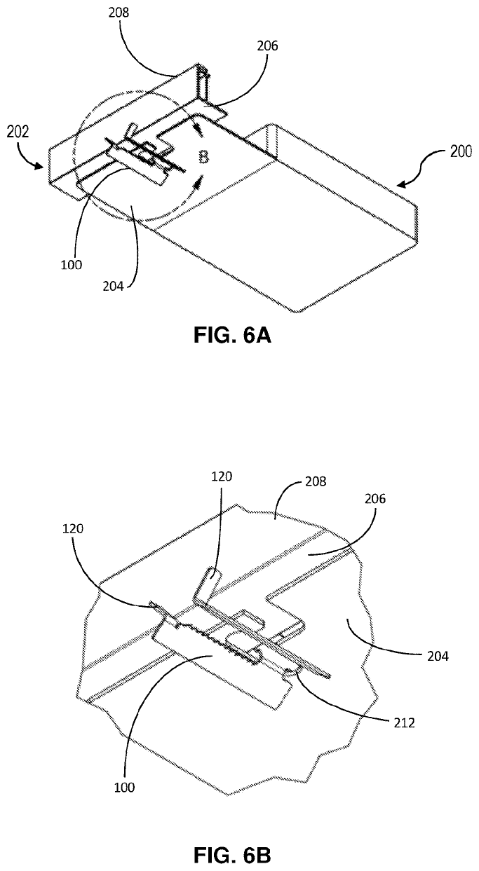

FIG. 6A shows a clamp 100 fully assembled on an MLPE device 200 and a PV module frame 202. FIG. 6B shows a close-up view of FIG. 6A along detail B. As shown in the figures, the clamp 100 may have completed its travel across the module frame mounting plate, such that flexible locking tabs 120 have reached the vertical wall 208 of the frame. Without any vertical pressure applied to the locking tabs, they may revert back to their relaxed state, as shown in FIGS. 6A-6B. The relaxed locking tabs 120 may serve to lock the module frame within the front receiver of the clamp, reducing the likelihood of the assembly from disassembling unexpectedly. Once the mounting plate 206 has been fully inserted within the front receivers 112 on top of the mounting bracket 204, the flexible locking tabs 120 clear the vertical member 208 and the locking tabs 120 return to their original position, thereby providing a locking engagement between the clamp 100 and the vertical member 208 of the mounting plate 206 (as best depicted in FIG. 6B). The engagement of the locking tabs with the mounting plate may serve to prevent lateral movement of the clamp. If the mounting plate 206 does not connect to a vertical member, the locking tabs would capture the side edge of the mounting plate 206.

It should be appreciated that in some embodiments, the clamping process may be reversible, allowing for the removal of the clamp. For example, downward pressure may be applied to the locking tabs (either manually or through the use of a tool) to allow the clamp to reverse its traversal across the mounting plate. The clamp may then be removed from the assembly in a reverse fashion from its assembly process. Thus, although the clamp may serve to provide a robust mechanical and electrical connection between the MLPE device and the PV module frame, the connection may be readily removable if needed.

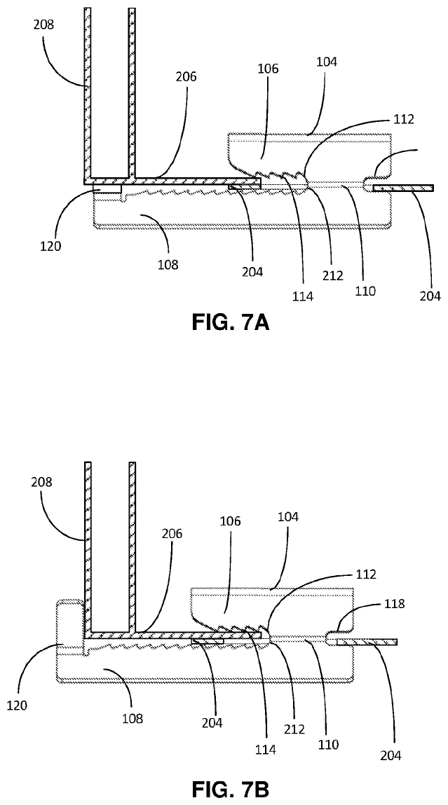

FIGS. 7A-7B show the assembly process of FIGS. 5A-6B from the side, with a cross-sectional view of the PV module frame and MLPE device for improved visibility. Thus, as illustrated in the cross-sectional views presented in FIGS. 7A-7B, the mounting bracket 204 may have already been captured within the front receivers 112 and back receivers 118 of the clamp 100 before the connecting to the PV module frame 202. When the MLPE device 200 and clamp are brought into contact with the PV module frame 202, the mounting plate 206 may urge the locking tabs 120 downward. During this step, the leg assemblies 102 may be compressed together by hand or with pliers or another compressive tool to increase the effective pass-through gap within the front receivers 112 to accommodate the stacked height of the mounting plate 206 and the mounting bracket 204 (shown in cross-section in FIGS. 7A-7B). In this way, the two legs or leg assemblies 102 may be configured to move between a compressed configuration in which two leg assemblies 102 are compressed towards one another by an external force and an engaged configuration in which the two leg assemblies 102 are pressed outward by a spring force applied by the apex joint 104 in combination with the spring force of the leg assemblies 102 themselves.

When the mounting plate 206 has been fully inserted into the front receivers 112, the locking tabs 120 clear the back side of the PV module frame 202 and spring back into their original position. The installer may hear a corresponding “click” or “snap” as the locking tabs 120 extend upward to capture the vertical member 208 of the PV module frame 202. In this way, the installer may receive audible and/or tactile feedback regarding the assembly status of the clamp 100, confirming that the mounting plate 206 has been fully engaged within the clamp 100.

As shown in FIGS. 7A-7B, the mounting plate 206 may be entirely retained between the front receiver 112 and the back edge of the locking tabs 120. Engagement between the teeth of the front receiver and the mounting plate 206 may further serve to retain the mounting plate within the clamp. Accordingly, once the clamp is locked to the mounting plate (e.g., the locking tabs abutting against the vertical member 208, as shown in FIG. 7B), the clamp may prevent lateral movement, which may be designated by movement aligned with the insertion direction of the mounting plate within the front receivers, of the mounting plate. Engagement between the front 112 and back 118 receivers of the clamp with the module frame 202 may serve to prevent lateral movement (e.g., aligned with the insertion direction) of the module frame 202. Engagement between the front receiver and the module frame and mounting plate positioned within the front receiver (see FIG. 7B) may serve to secure the two components together to prevent movement at various angles (e.g., normal) to the lateral direction, essentially locking the two structural components together.

It should be appreciated that in some embodiments, the locking tabs 120 may not be spring-loaded. Instead, the locking tabs 120 may be extended upward by hand or with the use of a tool such as pliers, and conversely, depressed manually for the unlocking and removal of the MLPE device when necessary. The compressive force applied to the leg assemblies 102 may be released so that the clamp 100 applies a vertically compressive force on the mounting plate 206 and the mounting bracket 204. The upper teeth 114 and lower teeth 116 grip the mounting plate 206 and mounting bracket 204, respectively. The combination of the clamping force presented by the leg assemblies 102, the engagement between the locking tabs 120 and the vertical member 208 of the PV module frame 202, and the engagement between the back receivers 118 and the mounting bracket 204 of the MLPE device 200 may provide a robust and secure connection between the MLPE device 200 and the PV module frame 202.

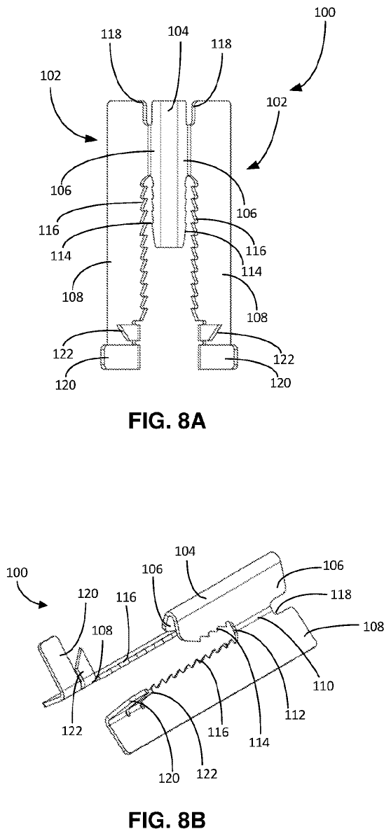

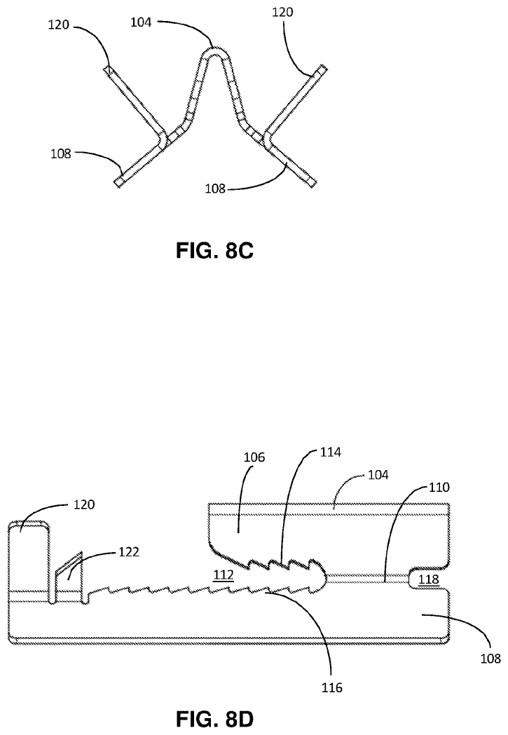

FIGS. 8A-8D show various views of a clamp 100 according to some embodiments. Unless otherwise noted, each feature of the embodiments represented by FIGS. 8A-8B may be the same as the corresponding feature in the embodiments described above. As shown in FIGS. 8A-8D, each leg assembly 102 of the clamp 100 may include a bonding tab 122 extending upward from the lower leg 108 adjacent or proximate to the corresponding locking tab 120. The bonding tabs may therefore lie closer to the front receiver as compared to the locking tabs. In this way, the bonding tabs 122 are each located toward a distal, front portion of the corresponding lower leg 108. The bonding tabs 122 may include sharpened points that are configured to score or gouge the underside of the mounting plate 206 of the PV module frame 202. In some embodiments, the bonding tabs 122 may be hingedly connected to the lower legs 108, as described previously relative to the locking tabs, such that they may also be able to be deflected during installation. In some embodiments, the sharpened points of the bonding taps may be angled to facilitate the deflection process.

As shown in FIG. 8D, the bonding tab may have a vertical extension lower than the locking tab. In some embodiments, the bonding tabs 122 may remain at the underside of the mounting plate following installation. Thus, the shorter bonding tab extension may reduce the risk of the bonding tab being damaged or broken off following installation. Of course, bonding tabs commensurate in vertical extension to the locking tabs are also contemplated. It should be appreciated that although one bonding tab is shown in FIGS. 8A-8D per leg assembly, embodiments having more than one bonding tab per leg assembly are also contemplated. In some embodiments, the bonding tab may be used as a secondary locking tab.

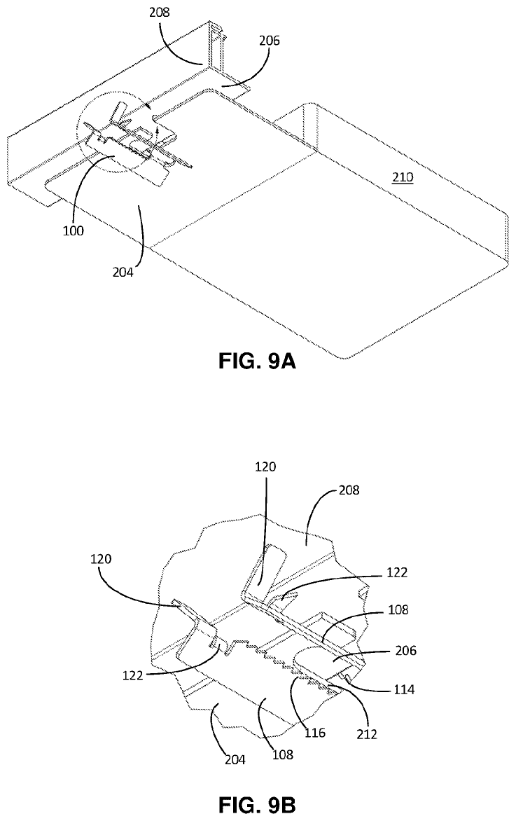

FIG. 9A shows the clamp 100 of FIGS. 8A-8D assembled on an MLPE device and a PV module frame. FIG. 9B shows a close-up view of FIG. 9A along detail C. As illustrated in FIGS. 9A-9B, the bonding tabs 122 remain in contact with the underside of the mounting plate 206 and ensure that a redundant electrical connection is made between the clamp 100 and the PV module frame 202.

As noted above, the clamp 100 depicted in FIGS. 8A-8D may initially be installed within the MLPE device 200 by inserting the upper legs 106 and apex joint 104 through one of the slots 212 of the mounting bracket 204 of the MLPE device 200. After insertion, the clamp 100 may become temporarily pre-positioned in the slot 212 of the MLPE mounting bracket 204 by the back receiver 118, which engages to the rear portion of the mounting bracket slot 212. At the same time, the front receiver 112 may receive at least a portion of the front portion of the mounting bracket slot 212.

To attach the MLPE device 200 to the PV module frame 202 with at least one pre-positioned clamp 100, the leg assemblies 102 of the clamp 100 may be compressed together, either by hand or by using pliers or a similar tool. As described previously, compression of the leg assemblies may serve to increase the vertical gap or clearance between the upper and lower teeth 114, 116 of the front receivers 112, thereby facilitating the insertion of the clamp 100 against the mounting plate 206 of the PV module frame 202. This insertion may occur through a sliding motion, which allows the front receiver 112 to receive both the MLPE mounting bracket 204 and the mounting plate 206 of the PV module frame 202.

The compression of the leg assemblies 102 may also change the angle of the flexible locking tabs 120 at the leading end portion of the lower legs 108, which is configured to provide the clearance necessary for the insertion of the mounting plate 206 into the front receiver 112 through the sliding motion. Once the mounting plate 206 reaches its final position within the front receiver 112, and the flexible locking tabs 120 achieve enough clearance underneath the mounting plate 206 of the PV module frame 202, the flexible locking tabs 120 may spring-back to their original position, providing a bearing mechanism against the outside of the vertical member 208 of the PV module frame 202. This spring-back action may provide tactile, visual, and acoustic feedback informing the installer that the clamp 100 is fully locked and the MLPE device 200 is securely attached to the PV module frame 202.

In some embodiments, when the leg assemblies 102 of the clamp 100 are released from the compressive force, the spring-back mechanism of the clamp 100 may cause the leg assemblies 102 to spread apart, thereby reducing the vertical height of the gap or clearance between the front receivers 112, thus effectively clamping and electrical bonding the MLPE mounting bracket 204 to the mounting plate 206 of the PV module frame 202.

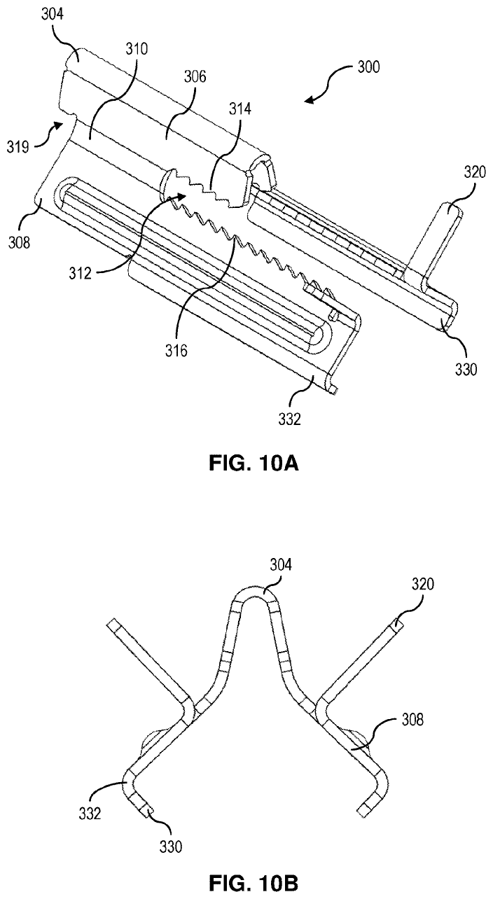

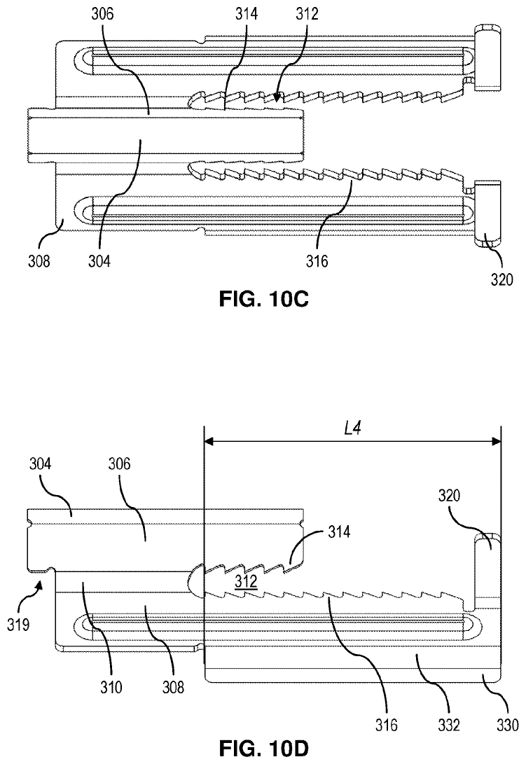

FIGS. 10A-10D show a clamp 300 according to some embodiments. Unless otherwise noted, each feature of the embodiments represented by FIGS. 10A-10D may be the same as the corresponding feature in the embodiments described above. In some embodiments, the clamp 300 may include a back receiver 319 formed in only the upper leg 306, such that the distal end portion of the upper leg 306 may extend further than the distal end portion of the lower leg 308 to form a shelf at the trailing end or distal end portion of the clamp. The distal end portion of the upper leg 306 may therefore engage with an upper surface of the MLPE mounting bracket 204. In some embodiments, the shelf-like back receiver may serve to temporarily support the clamp against the slot of the MLPE device during the installation process, for example, prior to the engagement of the teeth with the MLPE device and/or module frame. The shelf-like back receivers 319 may also work along with gravitational forces to facilitate fastening between a PV module frame and an MLPE device. In operation, the back receiver 319 may hook onto the backside of a slot formed in the MLPE device and apply a vertically downward force when fastening the structure assembly.

In some embodiments, the clamp 300 may include handling portions 330 extending from the leading edge of the clamp to a distance L4, as best depicted by FIG. 10D. The handling portions may overlap with the upper leg 306, but may not extend along the entire length of the clamp. In some embodiments, applying compressive forces to the handling portions 330 may result in a torque or twisting of the lower leg 308, relative to the upper leg 306. This compression may increase the vertical gap or clearance of the front receiver 312 to facilitate the positioning of one or more structural components within the clamp 300.

In some embodiments, the handling portions 330 may be a bent portion of the lower leg 308, with curvature 332 in between, as shown in FIG. 10B. For example, the handling portions may form a concave shape that angles back inwards towards an interior of the clamp in some embodiments. The curvature may provide a smooth surface for an installer to apply manual pressure with their hands. Furthermore, the shape of the handling portions 330 and curved portion 332 may serve as a moment arm, such that a lower amount of pressure may need to be applied to the lower legs 308 to expand the front receiver. In some embodiments, the handling portions 330 may facilitate the rotation of the lower legs 306 to an almost vertical, configuration to accommodate large structural components within the clamp.

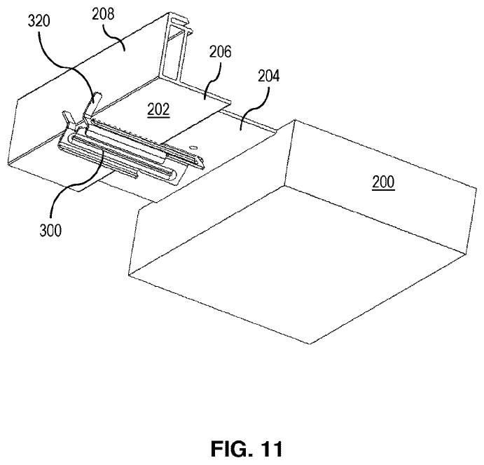

FIG. 11 shows the clamp 300 of FIGS. 10A-10D fastening an MLPE device 200 and a PV module frame 202 according to some embodiments. As shown, the locking tabs 320 of the clamp 300 may abut against a vertical wall 208 of the frame, helping to retain the frame and MLPE device together.

It should be appreciated that in any of the clamp embodiments described herein, any suitable order of structures may be arranged within the clamp. For example, in some embodiments, an MLPE device may be arranged beneath a PV module frame, as shown in FIG. 9A. In other embodiments, a PV module frame may be arranged beneath an MLPE device, as shown in FIG. 11. Accordingly, the present disclosure is not limited by the arrangement of the various structures fastened by the clamp.

In some embodiments, the arrangement of the MLPE device, which may include a slot through which the clamp is inserted (see slot 212 in FIG. 2) above the PV module frame may result in the back receiver 319 of the clamp 300 (see FIG. 10D) to abut against a mounting bracket of the MLPE device, thereby applying pressure to the stack of structures within the clamp, to further facilitate the clamping process between the various components. The shelf-like shape of the back receiver may allow the receiver to apply clamping force in a vertically downward direction to any suitable structure, irrespective of thickness, as the shelf-like shape may not require a particular combined thickness of the stack.

It should be appreciated that any of the clamps of the present disclosure may include the back receiver shelves shown and described relative to clamp 300. Similarly, any of the clamps described herein may include the handling portion 330 and/or curved portion 332.

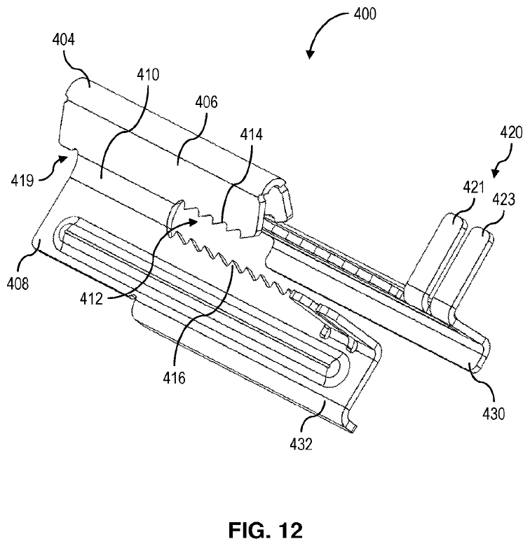

FIG. 12 shows a clamp 400 according to other embodiments. Unless otherwise noted, each feature of the embodiment represented by FIG. 12 may be the same as the corresponding feature in the embodiments described above. Clamp 400 may include more than one locking tab 420 on an end portion of the lower leg 408. Each of the locking tabs on the legs may be constructed and function in a manner that is similar to that described above relative to the single pair of locking tabs included in other embodiments. For example, as shown in FIG. 12, the clamp 400 may include a series of locking tabs 421, 423 arranged in a serial fashion along the upper surface of one or both lower legs 408. The presence of multiple locking tabs may render the clamp 400 suitable for use in clamping structures of various lengths within a predetermined size range. As the clamp 400 is slid across a PV module frame of varying sizes, the locking tabs may sequentially pop up (if spring-loaded, or manually be bent upwards) depending on the size of the frame causing a length of the opening formed by the receiver slot 412 and the innermost extended locking tab to change to accommodate a corresponding length of the structures inserted into the receiver slot. In some embodiments, the serial locking tabs may serve as redundant support structures, in case of failure of one or more of the locking tabs.

The clamps of the present disclosure may have any suitable number of locking tabs, such as two locking tabs per lower leg, as shown in FIG. 12. Other embodiments, such as clamps having less than two locking tabs per lower leg, and clamps having more than two locking tabs per lower leg, are also contemplated.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

1. A clamp for connecting a bracket to a frame, the clamp comprising:
two leg assemblies configured to move between a first compressed configuration with the two leg assemblies compressed towards one another and a second engaged configuration;
a plurality of front receiver slots, each of the plurality of front receiver slots formed in a respective one of the two leg assemblies, wherein the plurality of front receiver slots are configured to receive a portion of the bracket and a portion of the frame therein; and
a plurality of locking tabs formed at a leading end portion of a respective one of the two leg assemblies, the plurality of locking tabs configured to abut against a vertical surface of at least one of the bracket and the frame to prevent lateral movement of the clamp.

2. The clamp of claim 1, wherein each of the plurality of locking tabs is configured to move between a locking position and a deflected position.

3. The clamp of claim 2, wherein the plurality of locking tabs are spring-based.

4. The clamp of claim 1, wherein each leg assembly comprises more than one locking tab.

5. The clamp of claim 1, wherein the two leg assemblies extend downward from an apex joint of the clamp, and wherein each of the two leg assemblies comprise an upper leg and a lower leg.

6. The clamp of claim 5, wherein the lower leg is longer than the upper leg.

7. The clamp of claim 5, wherein the plurality of front receiver slots each comprise a plurality of teeth formed on the upper leg and a plurality of teeth formed on the lower leg.

8. The clamp of claim 5, wherein each leg assembly includes an intermediate joint between the upper leg and the lower leg, and wherein the intermediate joint creates an obtuse angle between the upper leg and the lower leg.

9. The clamp of claim 1, further comprising a plurality of back receiver slots, each of the plurality of back receiver slots formed in at a trailing end portion of a respective one of the two leg assemblies, wherein the plurality of back receiver slots are configured to receive at least a portion of the bracket therein.

10. The clamp of claim 1, further comprising a bonding tab arranged proximal to each of the plurality of locking tabs, the bonding tab having a sharpened point.

11. The clamp of claim 1, wherein the bracket is part of a module-level power electronics (MLPE) device, and the frame is part of a solar panel assembly.

12. A clamping system for clamping a solar panel assembly to a module-level power electronics (MLPE) device, the clamping system comprising:
a bracket of the MLPE device;
a frame of the solar panel assembly; and
a clamp configured to approximate the bracket to the frame, the clamp comprising:
two leg assemblies configured to move between a first compressed configuration with the two leg assemblies compressed towards one another and a second engaged configuration;
a plurality of front receiver slots, each of the plurality of front receiver slots formed in a respective one of the two leg assemblies, wherein the plurality of front receiver slots are configured to receive a portion of the bracket and a portion of the frame therein; and
a plurality of locking tabs formed at a leading end portion of a respective one of the two leg assemblies, the plurality of locking tabs configured to abut against a vertical surface of at least one of the bracket and the frame to prevent lateral movement of the clamp.

13. The clamping system of claim 12, wherein each of the plurality of locking tabs is configured to move between a locking position and a deflected position.

14. The clamping system of claim 13, wherein the plurality of locking tabs are spring-based.

15. The clamping system of claim 12, wherein each leg assembly comprises more than one locking tab.

16. The clamping system of claim 12, wherein the two leg assemblies extend downward from an apex joint of the clamp, and wherein each of the two leg assemblies comprise an upper leg and a lower leg.

17. The clamping system of claim 16, wherein the lower leg is longer than the upper leg.

18. The clamping system of claim 16, wherein the plurality of front receiver slots each comprise a plurality of teeth formed on the upper leg and a plurality of teeth formed on the lower leg.

19. The clamping system of claim 12, further comprising a plurality of back receiver slots, each of the plurality of back receiver slots formed in at a trailing end portion of a respective one of the two leg assemblies, wherein the plurality of back receiver slots are configured to receive at least a portion of the bracket therein.

20. The clamping system of claim 12, further comprising a bonding tab arranged proximal to each of the plurality of locking tabs, the bonding tab having a sharpened point.

21. A method of connecting a bracket to a frame, the method comprising:
applying an external force to two leg assemblies of a clamp to transition the two leg assemblies between a first compressed configuration a second engaged configuration;
receiving a portion of the bracket and a portion of the frame within a plurality of front receiver slots, each of the plurality of front receiver slots formed in a respective one of the two leg assemblies; and
preventing lateral movement of the clamp by abutting a plurality of locking tabs formed at a leading end portion of a respective one of the two leg assemblies against a vertical surface of at least one of the bracket and the frame.

22. The method of claim 21, further comprising moving each of the plurality of locking tabs between a locking position and a deflected position.

23. The method of claim 21, further comprising preventing lateral movement of the clamp by abutting more than one locking tab formed in each leg assembly against the vertical surface.

24. The method of claim 21, further comprising vertically inserting an apex joint of the clamp through a slot of the bracket, wherein the two leg assemblies extend downward from an apex joint of the clamp, and wherein each of the two leg assemblies comprise an upper leg and a lower leg.

25. The method of claim 24, further comprising:
scratching a surface of the bracket or the frame with a plurality of teeth formed on the upper leg; and
scratching a surface of the other of the bracket or the frame with a plurality of teeth formed on the lower leg.

26. The method of claim 21, further comprising receiving at least a portion of the bracket in a plurality of back receiver slots, each of the plurality of back receiver slots formed in at a trailing end portion of a respective one of the two leg assemblies.

27. The method of claim 21, further comprising scratching a surface of at least one of the bracket or the frame with a bonding tab arranged proximal to each of the plurality of locking tabs, the bonding tab having a sharpened point.

28. The method of claim 21, wherein the bracket is part of a module-level power electronics (MLPE) device, and the frame is part of a solar panel assembly.

29. A clamp for connecting a bracket to a frame, the clamp comprising:
two leg assemblies configured to move between a first compressed configuration with the two leg assemblies compressed towards one another and a second engaged configuration;
a plurality of front receiver slots, each of the plurality of front receiver slots formed in a respective one of the two leg assemblies, wherein the plurality of front receiver slots are configured to receive a portion of the bracket and a portion of the frame therein; and
a plurality of shelves, each of the plurality of shelves formed in a trailing end portion of a respective one of the two leg assemblies, wherein the plurality of shelves are configured to receive at least a portion of the bracket therein.

30-39. (canceled)

40. A clamping system for clamping a solar panel assembly to a module-level power electronics (MLPE) device, the clamping system comprising:
a bracket of the MLPE device;
a frame of the solar panel assembly; and
a clamp configured to approximate the bracket to the frame, the clamp comprising:
two leg assemblies configured to move between a first compressed configuration with the two leg assemblies compressed towards one another and a second engaged configuration;
a plurality of front receiver slots, each of the plurality of front receiver slots formed in a respective one of the two leg assemblies, wherein the plurality of front receiver slots are configured to receive a portion of the bracket and a portion of the frame therein; and
a plurality of shelves, each of the plurality of shelves formed in at a trailing end portion of a respective one of the two leg assemblies, wherein the plurality of shelves are configured to receive at least a portion of the bracket therein.

41-49. (canceled)

50. A method of connecting a bracket to a frame, the method comprising:
applying an external force to two leg assemblies of a clamp to transition the two leg assemblies between a first compressed configuration a second engaged configuration;
receiving a portion of the bracket and a portion of the frame within a plurality of front receiver slots, each of the plurality of front receiver slots formed in a respective one of the two leg assemblies; and
receiving a portion of the bracket within a plurality of shelves, each of the plurality of shelves formed in at a trailing end portion of a respective one of the two leg assemblies.

51-59. (canceled)
